(19) United States
(12) Patent Application Publication
(10) Pub. No.: US 2016/0368798 A1
(43) Pub. Date: Dec. 22, 2016

(54) METHOD AND SYSTEM OF ENHANCED AEROBIC DIGESTION

(71) Applicant: Karcher North America, Inc., Denver, CO (US)

(72) Inventors: Allen Hurtado, Vancouver, WA (US); Roland Nielsen, Battle Ground, WA (US); Greg Kowalsky, Portland, OR (US); Shannon Taylor, Vancouver, WA (US); Dean A. Derek, Gresham, OR (US); Dana Sean Plummer, Yacolt, WA (US)

(21) Appl. No.: 15/189,183

(22) Filed: Jun. 22, 2016

Related U.S. Application Data
(60) Provisional application No. 62/182,930, filed on Jun. 22, 2015.

(51) Int. Cl. C02F 3/02

(52) U.S. Cl. CPC C02F 3/02; C02F 2101/30

(57) ABSTRACT

A system and method for biological digestion of waste materials in a fluid are provided. The system comprises a tank that is operable in batch mode or in a flow-through mode. A tank and liquid-gas exchanger are provided. Fluid and gas from both the tank and exchanger may be selectively routed and re-routed to desired locations within the system to achieve and optimize aerobic and anaerobic digestion processes occurring within the tank or tanks.

This U.S. Non-Provisional Patent Application claims the benefit of priority from U.S. Provisional Patent Application Ser. No. 62/182,930, filed Jun. 22, 2015, the entire disclosure of which is hereby incorporated by reference in its entirety.

### FIELD

The present disclosure generally relates to water treatment systems. More specifically, embodiments of the disclosed system relate to novel equipment and methods for water treatment using enhanced anaerobic and aerobic processes.

### BACKGROUND

Industrial and commercial processes that use water for production and cleaning produce aqueous waste streams that become contaminated with a wide range of pollutants. A major constituent of the waste is organic (i.e. carbon-containing) material which can be present in a broad range of chemical combinations. Organic waste (BOD) can be decomposed by aerobic and/or anaerobic microbial digestion. As part of an integrated waste management and treatment system, microbial digestion under controlled conditions provides a means for reducing biodegradable and organic waste into relatively harmless elemental products.

A primary factor in the performance of aerobic digestion of BOD is the amount of oxygen present in the fluid. Known devices for sustaining the digestion of organic material utilize air pumps or blowers to force air directly into fluid to be treated, and diffusers to create small bubbles in the fluid to increase contact time with BOD and surface area between the air and fluid.

### SUMMARY

Embodiments of the described system provide methods and systems for introducing and circulating a waste fluid stream into at least one tank or vessel including microbes and chemical additives, a fluidizable substrate media to support the microbial colony, and an oxygen exchanger. As the waste fluid stream enters the tank, microbes begin to digest the organic material and consume oxygen dissolved in the water. In certain embodiments, a fluid stream is pumped through a liquid volume chamber at a specific upward velocity of between approximately 0.10 to 0.50 cubic feet per minute before exiting or recirculating through the treatment system. In preferred embodiments, a fluid stream is pumped through a liquid volume chamber at a specific upward velocity of between approximately 0.17 to 0.26 cubic feet per minute before exiting or recirculating through the treatment system.

In certain embodiments, an oxygen exchanger operates as a separate chamber that is housed or located within a primary digester chamber. Within the oxygen exchanger, a fluid stream and an atmospheric air stream are mixed in counter-flow fashion to react and impart atmospheric oxygen from the air stream into the fluid stream. Fluid from the chamber is pumped or otherwise transmitted to an oxygen exchanger, which is preferably filled with a column of media that fragments and exponentially expands the exposed surface area of the fluid stream volume as it trickles or flows down to a base of the exchanger where the fluid is extracted, and may later be returned to the chamber. Concurrently with operation of the fluid flow, atmospheric or ambient air is pumped to a bottom of the oxygen exchanger and allowed to flow upwardly through the exchanger in counter-flow to the fragmented down-flow fluid steam, and ultimately exists the top of the exchanger where it may be exhausted or employed to aerate auxiliary vessels. These systems and processes allow oxygen from the air to become dissolved in the fluid to be treated and that oxygen is used to support aerobic digestion of organic material by microbes in the fluid.

The fluid flow rate and air flow rate can be independently varied to maximize oxygen exchange and system energy efficiency. The oxygen exchange column may be partially filled with media to spread out the fluid flow to increase the contact area between the fluid and air.

The exchanger may be mostly filled with air, where the fluid trickles across the media, or the exchanger may be mostly filled with fluid, where the air bubbles through the water. The fluid flow may be from top to bottom counter to the upward air flow, but it could also be set up to have the fluid flow from the bottom to the top. The exchanger is pictured as a vertical cylindrical tube, but could be any shape that allows the air and fluid to mix, including lengthening the exchanger or creating a tortuous path for the air and fluid to increase the contact time between air and fluid.

In certain embodiments, an oxygen exchanger is provided within a treatment tank to reduce the overall size and footprint of the system. Alternatively, however, one or more oxygen exchangers as shown and described herein are provided external to the tank to increase tank volume and/or employ a larger exchanger.

Embodiments of the system may be operated in a “batch mode” wherein a tank is filled with wastewater to undergo treatment. The wastewater is allowed to stand and be subjected to a digestion processes for a set duration. The wastewater is evacuated once a desired bio-digestion process has reached a desired completion state. Alternatively, embodiments of the described system can be operated in a continuous fashion where wastewater to be treated is constantly fed into a tank and a processed fluid is simultaneously released. The input and output in such a situation may comprise substantially the same flow rates to provide a substantially steady fluid flow through the system, or the input and output flow rates may not be substantially the same so as to create a build-up or emptying of the tank or vessel. Embodiments of the described system contemplate a flow rate of between one and twenty gallons of fluid per minute, depending on the type of fluid stream supplied. However, no particular limitation is provided herewith regarding a flow rate of the device. Rather, size and flow rate of embodiments of the disclosed system could be scaled up or down to be optimized for performance and application requirements. It will be recognized that various novel features of the described system are not limited to or governed by a flow rate of portions of the system.

System embodiments described herein contemplate operation with a variety of bio media substrates, and/or various fluids and wastes to be treated. Accordingly, the described system is not limited to any particular material(s).

In various embodiments, a modular system is provided that is scalable to accommodate a wide range of flow range and contaminant loads. In certain system embodiments, a counter-flow aeration tower is provided that is contained within a digester assembly. The aeration tower comprises a dissolved oxygen mass transfer efficiency that is greater than can be achieved with direct aeration methods. The aeration tower provides temperature regulation to within a desirable range through ambient heating and evaporative cooling where desired to reduce excess heat build-up or increase frigid temperature in a fluid or water to be treated.

In certain system embodiments, spent or exhausted air or gas from the oxygen exchanger is redirected or recycled through one or more additional digester device(s) to increase efficiencies. In various system embodiments, air or exhaust flows are adjustable to allow for optimization of contact between an air stream and a fluid stream and to optimize biological activity. In certain system embodiments, a blower or other device is provided to increase a temperature of air or gas and thus transfer thermal energy to a fluid when ambient air temperatures are near or above the fluid temperature and thus may enhance biological activity when the water temperature is below the optimal point for bio-digestion. In such system embodiments, an air flow is provided through an auxiliary heater to transfer heat to a fluid and enhance efficiencies, particularly in colder climates.

In preferred system embodiments, at least a portion of an exhaust air or gas is redirected back to one or more auxiliary treatment tanks to fluidize and move a floating media bed and strip excess biomass to fall and be reinstructed into an aerobic digestion process. In certain other system embodiments, at least a portion of fluid can be redirected to fluidize and move a floating media bed, stripping excess biomass and allowing the fluid to be reintroduced to an aerobic digestion processes. Other system embodiments provide various unique combinations of tank configurations and flow paths to enable or disable anoxic and anaerobic zone and sludge formation, avoiding methane formation generated by some waste streams. System embodiments also contemplate use of various interconnected conduits wherein fluid flows within the conduits are selectively controlled by a plurality of valves, pumps, and similar devices. In certain embodiments, at least some control valves of the system comprise manually-controlled valves (such as hand-operated ball valves). In other system embodiments, one or more valves are controlled by solenoids, motors, pistons or other actuators which may be automatically and/or manually controlled. For example, where certain fluid fill levels within the system are determined to be excessive or inadequate, sensors provided within the system can signal one or more valves to open or close and activate the appropriate filling or emptying operation of the tank or other fluid-containing vessel.

In one system embodiment, a treatment system for treating a liquid is provided, the system comprising a tank with an interior volume, the tank comprising a first outlet for tank contents, the outlet provided in a lower portion of the tank and wherein the tank's contents are gravity fed to the first outlet. A fluid-gas exchanger is provided in fluid communication with the tank. A pump is provided for directing fluid from the first outlet to the interior volume of the tank, a location external to the tank, and/or to an inlet of the fluid-gas exchanger. The fluid-gas exchanger comprises a second outlet, the second outlet being in selective fluid communication with the interior volume of the tank and an inlet of the fluid-gas exchanger, and the inlet of the fluid-gas exchanger is in fluid communication with a blower for directing atmospheric air into the fluid-gas exchanger. The treatment system may comprise a fluid-gas exchanger provided at least partially within the interior volume of the tank, or the fluid-gas exchanger may be provided at various external or partially-external locations with respect to the system. The treatment systems of certain embodiments comprise a fluid-gas exchanger including a vertically oriented column for oxygenating a fluid using ambient air. A fluid outlet is provided proximal to a lower portion of the column and a gas outlet is provided proximal an upper portion of the column.

In another embodiment, a different treatment system for treating a liquid is provided. The system comprises a tank comprising an upper portion, a lower portion, and an interior volume. The upper portion comprises a substantially cylindrical portion and the lower portion comprising a conical portion. The tank comprises a first outlet for discharge of tank contents, the first outlet being provided in the lower portion of the tank. A fluid-gas exchanger is provided at least partially within the interior volume of the tank, the fluid-gas exchanger operable to allow for mixing or interaction of at least one liquid and at least one gas, and an upper portion of the fluid-gas exchanger extends above a maximum fill level of the tank. The fluid-gas exchanger comprises a second outlet, and a blower is provided in fluid communication with a first inlet of the fluid-gas exchanger, the blower operable to direct an airflow into the fluid-gas exchanger. A pump is provided in selective fluid communication with the first outlet and the second outlet, and the pump is operable to direct a fluid from the first outlet and/or the second outlet to the interior volume of the tank, a location external to the tank, and to a second inlet of the fluid-gas exchanger. At least one valve is in fluid communication with the pump to selectively change a fluid flow path.

In another embodiment, a treatment system for treating a liquid comprises a tank with an interior volume, and the tank comprises a first outlet for tank contents, the outlet provided in a lower portion of the tank and the tank contents are gravity fed to the first outlet. A fluid-gas exchanger is provided in fluid communication with the tank, the fluid-gas exchanger comprising a first conduit and a second conduit. The first conduit comprises an air entry path and the second conduit comprises a fluid flow path, and the first conduit is provided within the second conduit. A blower is provided in fluid communication with the fluid-gas exchanger and is operable to direct an airflow into the fluid-gas exchanger. A pump is provided for directing fluid from the first outlet to the interior volume of the tank, a location external to the tank, and/or to an inlet of the fluid-gas exchanger. The fluid-gas exchanger comprises a second outlet, the second outlet in selective fluid communication with the interior volume of the tank and an inlet of the fluid-gas exchanger.

In another embodiment, a treatment system for treating a liquid comprises a tank comprising an upper portion, a lower portion, and an interior volume. The upper portion comprises a substantially cylindrical portion and the lower portion comprises a conical portion. The tank comprises a first outlet for tank contents, the first outlet provided in the lower portion of the tank. A fluid-gas exchanger is provided at least partially within the interior volume of the tank, the fluid-gas exchanger operable to allow for mixing or interaction of at least one liquid and at least one gas, and an upper portion of the fluid-gas exchanger extends above a maximum fill level of the tank. A blower is provided in fluid communication with a first inlet of the fluid-gas exchanger, the blower operable to direct an airflow into the fluid-gas exchanger. A pump is provided for directing fluid from the first outlet to the interior volume of the tank, a location external to the tank, and/or to a second inlet of the fluid-gas exchanger.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system.

FIG. 1 is a schematic of a water treatment system according to one embodiment of the disclosed system.

FIG. 2 is a front elevation view of a water treatment system according to one embodiment of the disclosed system.

FIG. 3 is a rear elevation view of a water treatment system according to one embodiment of the disclosed system.

FIG. 4 is a detailed perspective view of features of a water treatment system according to one embodiment of the disclosed system.

FIG. 5 is a front view of a water treatment system according to one embodiment of the disclosed system.

FIG. 6 is a top view of a water treatment system according to one embodiment of the disclosed system with certain features removed for illustration purposes.

FIG. 7 is a diagram of a water treatment system according to one embodiment of the disclosure.

FIG. 8 is a top view of the water treatment system of FIG. 7.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular system embodiments illustrated herein.

### DETAILED DESCRIPTION

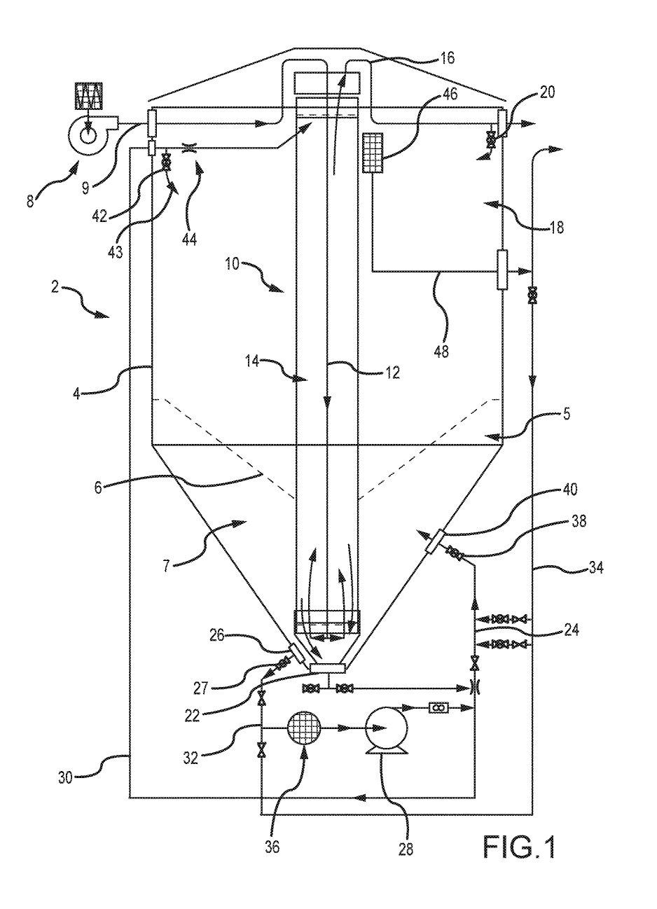

FIG. 1 is a schematic view of a water treatment system 2. As shown, the system 2 comprises a tank 4, the tank comprising a conical or frustoconical bottom portion end with a cylindrical upper portion. The tank 4 comprises a perforated inverted cone 6 extending downwardly toward the bottom of the tank 4. A blower 8 is provided for producing airflow to be injected into the tank 4. The blower 8 is operably connected to an air conduit 9 to convey airflow. In certain embodiments, the blower is provided with or coupled to an inlet air filter. The blower produces an airflow that is directed into an internal volume of the tank 4, and more specifically into a fluid-gas exchanger 10, which may be provided in the form of at least one conduit or pipe. In certain embodiments, the exchanger 10 comprises a packed column with forced-draft counterflow aeration. Specifically, and in the embodiment provided in FIG. 1, the exchanger 10 comprises an outer pipe 14 (e.g. 10″ PVC pipe) with an internal conduit 12. The internal conduit 12 comprises an air entry path for conveying airflow from the blower 8 to the bottom of the internal conduit 12 where air is allowed to mix with or aerate a solution or volume of water at a lower portion of the outer pipe 14 and at a lower portion of the exchanger 10.

The embodiment depicted in FIG. 1 comprises a counter-flow aeration system wherein an exchanger 10 is provided as a counter-flow aeration tower. As shown, the exchanger 10 comprises a feature wherein water or fluid from the tank 4 is pumped from a lower region 7 of the tank 4 through tank outlet 26 by a recirculation pump 28 and returned to at least one of the internal volume of the tank 7 and the exchanger 10 via return line 30. Water or fluid returned to the exchanger 10 via return line 30 is allowed to flow down to the base of the exchanger 10. In certain embodiments, a fluid inlet (such as a municipal water source) is connected to the system and preferably to the fluid line 30 such that clean fluid or water may be selectively injected into the system. A valve may be provided to direct the clean fluid either to the upper portion of the exchanger 10 or to the inlets 40 provided in a lower portion of the tank. In alternative embodiments, the system of FIG. 1 is not directly connected to such a fluid source, and the system comprises a contained system wherein water and fluid are added by alternative means (e.g. transferred from other containers or devices). Fluid, such as air, is pumped to the bottom of the exchanger 10 via blower 8 and allowed to flow upward through the exchanger to exit the top of the exchanger 10 via an outlet flow conduit 16. This system and process allows oxygen from ambient air, for example, to be provided in a water or fluid within the tank 4 to support aerobic digestion of organic material within the tank 4.

An air return flow is provided external to the internal conduit 12, but within the outer pipe 14. The internal conduit 12 comprises an outlet flow conduit 16 at an upper portion of the tank 4. The outlet flow 16 comprises an air exhaust from the exchanger 10, and the exhausted air may be conveyed to an additional stage digester (if provided), exhausted into an outside environment, and/or may be re-directed into an internal volume of the tank 4 to a fluidized buoyant media 18. The fluidized buoyant media is provided at an upper region of the tank 4 based on its buoyant characteristics. In various embodiments, the buoyant media comprises a biological material and generally corresponds to an area of anaerobic digestion within the tank 4.

A tunable or controllable valve 20 is provided to allow for selective control of the flow rate and direction of air introduced into the system. The exchanger 10, including the internal conduit 12 and outer pipe 14, provides a means for conveying air to a lower region of the tank 4 and allows oxygen from the air to be dissolved or entrained in a fluid within the exchanger 10. The aerated fluid may then be used to support aerobic digestion of organic material in a waste stream or tank volume. In various embodiments, the flow rates of water and air can be varied to maximize oxygen exchange and system efficiency. The exchanger 10 comprises an exchanger in the form of a vertical tube. Various alternative arrangements for an air-water or fluid-gas exchanger are contemplated, and no limitation with respect to such arrangement is provided herewith. Although the exchanger 10 of FIG. 1 is provided internal to a tank 4, the present invention is not so limited. Alternative embodiments of the described systems contemplate use of fluid-gas exchangers provided at least partially external to the tank 4 in order to increase the internal volume of the tank 4 or for various other reasons.

As shown in FIG. 1, systems 2 of certain disclosed embodiments provide multiple inlets and outlets for aeration and water or fluid treatment. As shown, a blower 8 provides air to at least one internal conduit 12 and wherein airflow is provided to a lower portion of the exchanger 10 to aerate a fluid provided within the columnar exchanger 10. In the embodiment provided in FIG. 1, the exchanger 10 comprises an internal conduit 12 and an outer pipe 14, the outer pipe containing a volume of water or fluid. A lower portion of the exchanger 10 comprises a primary outlet 22 for selectively allowing aerated fluid to drain from the exchanger 10. The primary outlet 22 comprises a gravity fed drain with a recycle conduit 24 for redirecting an aerated fluid (e.g. oxygenated water) from the exchanger 10 to an interior volume of the tank 4.

A tank outlet 26 is provided in a lower portion 7 of the tank 4 and external to the conduit 10. The tank outlet 26 comprises a drain or outlet for fluid provided in an interior volume of a lower portion 7 of the tank 4. Fluid from this lower portion 7 may exit through the tank outlet 26 through outlet line 32 under the force of gravity and be selectively diverted back to the lower portion 7 of the tank 4 via recycle line 24 by a recirculation and booster pump 28, or may be diverted away from the system 2 via outlet conduit 34. Fluid exiting a lower portion of the tank 7 may be diverted through a variety of flow paths or combinations thereof as shown and described. For example, a valve 27 such as a ball valve is provided to selectively control fluid flow from the tank 4. Fluid exiting the lower portion 7 of the tank 4 through the tank outlet 26 and valve 27 may be diverted away from the system via outlet conduit 34. In addition to or in lieu of flowing away from the system 2, fluid may be directed through fluid outlet line 32 through a high porosity filter 36 and through a recirculation pump 28. Downstream of the recirculation pump 28, fluid may either be directed back to an interior volume of the tank 4 via recycle line 24, or may be directed through the return line 30 and provided to the exchanger 10.

One or more valves, including ball valves, globe valves, gate valves, check valves, and other devices as will be recognized by one of ordinary skill in the art may be provided in various lines and conduits of the system to control or limit flow of fluid and, in certain instances, cause a flow through an alternate path. For example, in certain embodiments, a ball valve 38 provided proximal an oxygenated water inlet 40 is sufficient to control a fluid flow rate through the recycle line 24 and a corresponding flow rate through the return line 30. However, additional valves and/or pumps may be provided to increase user control of flow rates through the system 2.

As shown in FIG. 1, fluid is provided to an internal volume 5 of a water treatment tank 4 by at least one of: directing an oxygenated fluid from an exchanger 10 into the internal volume 5 of the tank 4; directing or recycling a fluid from within the internal volume 5 of the tank 4 through a recirculation pump back into the internal volume 5; and directing a combination of fluid directly from the internal volume 5 and an aerated fluid from the exchanger 10 back into the internal volume 5.

Still referring to FIG. 1, a return line 30 as shown and described herein is provided for directing a fluid from an internal volume 5 of the tank 4 and/or a fluid from the exchanger 10 back to an inlet of the exchanger 10. As shown, the return line 30 re-enters the tank 4 at an upper region thereof. A tuneable valve 42 is provided to selectively control an amount of fluid from the return line 30 that is provided to an internal volume 5 of the tank 4 by supply line 43. A remainder of the fluid from the return line 30 is directed to the exchanger 10. A flow restrictor 44 is provided in certain embodiments to limit the flow rate of the fluid to the exchanger. Fluid provided to the exchanger is gravity fed to a lower portion of the exchanger 10 and subject to counter-flow aeration as shown and described herein.

A fluidized buoyant media 18 is provided in an upper portion of the internal volume 5 of the tank 4. An outlet screen or course filter 46 is provided to allow for egress of the fluidized media from the tank 4 through an exit line 48. In the depicted embodiment, an outlet of the buoyant media 18 may be provided to and joined with outlet conduit 34 to be redirected to the lower portion of the tank 7 and/or conveyed away from the tank 4. Fluid exiting the tank 4 through exit line 48 and/or outlet conduit 34 may be disposed of or subsequently treated by additional digester devices or similar features. In certain embodiments, storage containers are provided such that contents of the tank 4 may be drained to achieve a desired fluid or water level within the tank 4 and without wasting contents.

FIG. 1 depicts various valves for controlling fluid flow rates through various portions and features of the system 2. It will be recognized, however, that various described embodiments are not limited to the quantity or positioning of the various valves and control devices depicted in FIG. 1. Rather, various embodiments are contemplated which use valves, flow restrictors, pumps, filters, etc. provided in various locations and as may be desired or required by a specific operation. The numerous advantages of the disclosed systems include modularity and adjustability of the system wherein certain features and conduits (for example) may be added or removed. Valves and similar devices may also be provided to accommodate such modularity and provide the necessary control capabilities for directing and redirecting fluid through the system 2. It will also be understood that no limitation with respect to specific types of valves and similar devices is provided herewith.

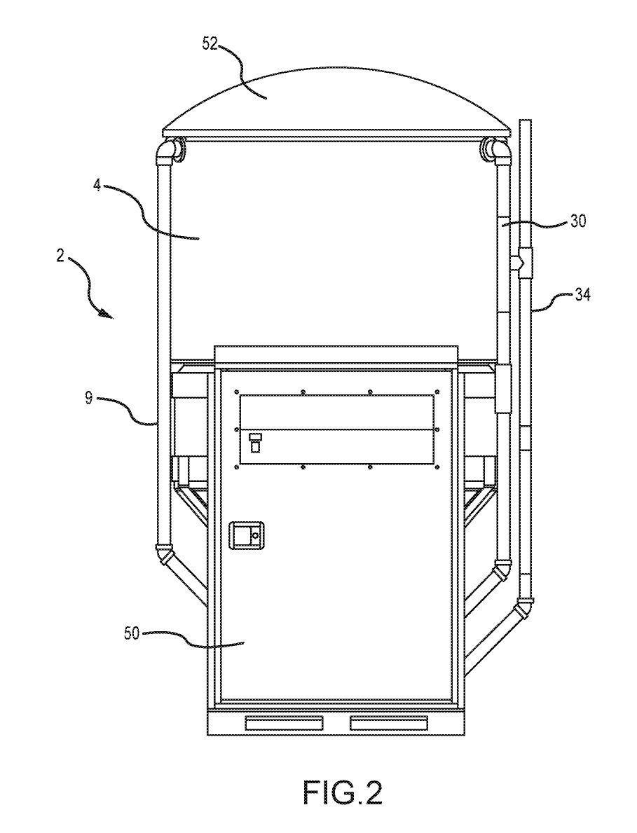

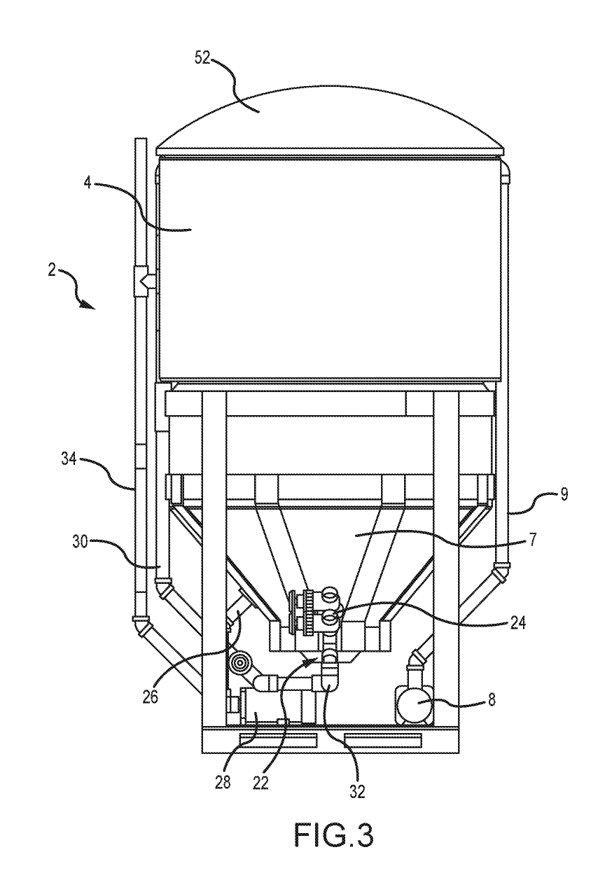

FIG. 2 is a front elevation view of a water treatment system 2 according to one system embodiment. As shown, the system 2 comprises a tank 4, an air conduit 9, a return line 30, and an outlet conduit 34. The system 2 further comprises a cabinet 50 provided adjacent the tank 4. In various embodiments, the cabinet 50 comprises various features of the present invention including, for example, control systems, power connections, general storage area, fluids for injection into the tank 4, and/or user interface(s) for controlling the system 2. The cabinet 50 as shown in FIG. 2 is typically provided on the same platform or skid as the tank 4. In alternative embodiments, however, it is contemplated that a cabinet 50 may be provided in various locations including remote locations. The system is not limited to equipment housed in the cabinet 50. The embodiment of FIG. 2 comprises a domed lid 52 that is selectively removable from the tank 4 for accessing an interior volume of the tank. Various features as shown and described with respect to the schematic view of FIG. 1 are also shown in the embodiment of FIGS. 2-3. It will be recognized, however, that the specific and relative arrangements of various features including tank outlets and conduits is not critical and placement or location of the same may be varied, particularly where the system 2 is to be customized for a specific application or setting.

FIG. 3 is a rear elevation view of the water treatment system 2 of the embodiment of FIG. 2. As shown, the system 2 comprises a tank 4. The tank comprises an internal exchanger (10 in FIG. 1) with an outlet 22 from which fluid within the exchanger may be diverted or transmitted to various locations, including back into the tank 4 via a recycle conduit 24 or away from the tank via outlet conduit 34. Outlet conduit 34 is shown as being open-ended in FIG. 3, but it will be recognized that this conduit may be connected or supplied to various different features including, for example, a second tank for storage or further treatment. The embodiment of FIG. 3 further comprises a blower 8 with a conduit 9 for conveying atmospheric air to an exchanger provided within the tank 4. Although the blower is shown as being provided generally beneath the tank 4, it will be recognized that one or more blowers, fans, pumps, etc. may be provided in various different locations for conveying air or other gases to the exchanger.

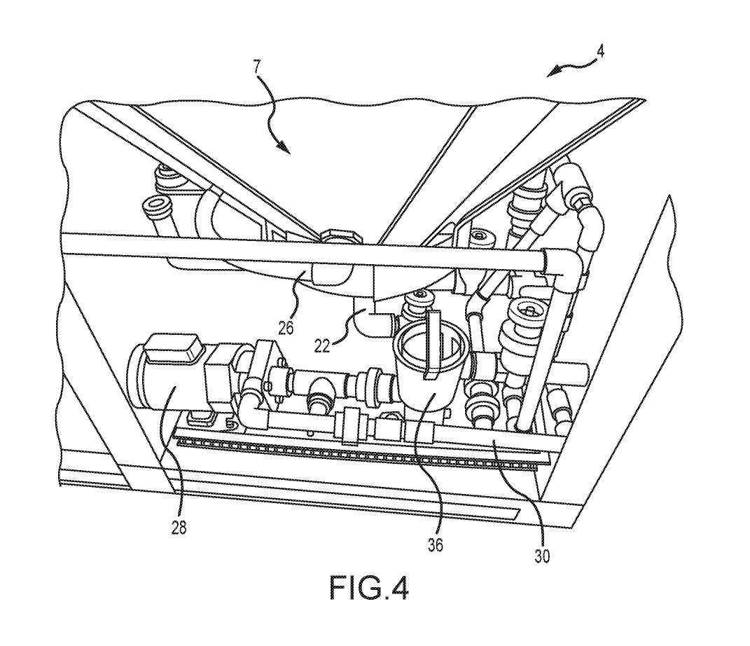

FIG. 4 is a perspective view of a portion of a water treatment system 2. A lower portion 7 of a tank 4 is shown, wherein a primary outlet 22 is provided as an outlet for an air-water exchanger provided within the tank 4. A tank outlet 26 is also provided to allow contents from within the tank 4, but external to the exchanger, to be drained or removed from the tank. In certain embodiments, fluid or contents from the tank 4 may be drained from the tank outlet 26 and passed through a high porosity filter 36 before reaching a recirculation pump 28. The recirculation pump 28 is provided to convey fluid back to an internal volume of the tank 4 and/or to vertically displace fluid to entry point of an exchanger provided within the tank 4 via return line 30. As previously described, contents from a primary outlet 22 may be conveyed to an internal volume of the tank, combined with a fluid flow from the tank 4, and/or conveyed to an inlet of an air-water exchanger. Tank contents drained or conveyed from a tank outlet 26 may be re-introduced to the tank (with or without mixing with contents from an exchanger), diverted to an inlet of an exchanger, and/or conveyed from the system to an external location or device for storage, disposal, or further treatment.

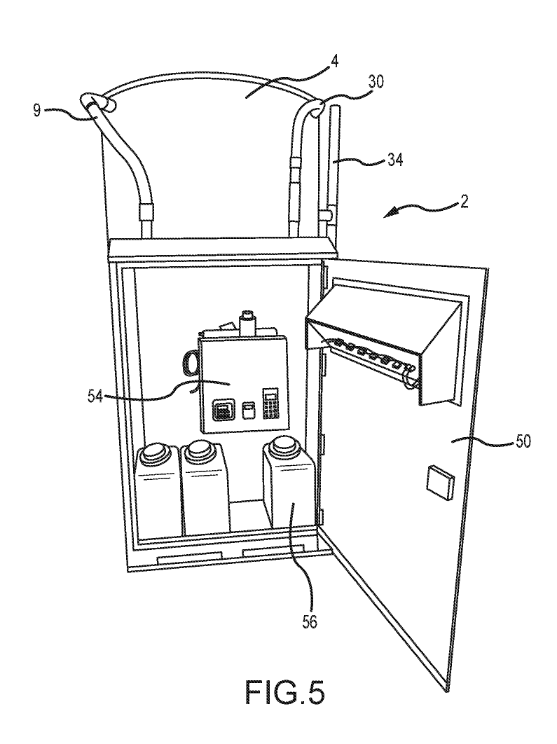

FIG. 5 is a front perspective view of a system 2 according to one embodiment of the system. The system 2 comprises a tank 4 and a cabinet 50 as shown and described herein. The cabinet 50 is provided in an open position in FIG. 5 to illustrate various features provided therein. As shown, the cabinet 50 comprises control means 54 for controlling and regulating various features and operations of the system 2. Control means may comprise various features and controls including, but not limited to various analytic devices such as flow meters, gauges, temperature readers (e.g. thermocouples), water quality sensors and process controllers, and various control devices such as circuit boards with built-in logic, solenoid valves, etc. In certain embodiments, the cabinet 50 also comprises one or more stored fluids or solutions 56 for selective injection into the tank 4 and/or exchanger 10 provided within the tank. It will be recognized, however, that the cabinet 50 is not limited to any particular contents or purpose. Indeed, various uses for the cabinet 50 are contemplated, including general storage, fire suppression systems, pump housings, etc. In certain embodiments, a cabinet or control system is not provided adjacent to or connected with the tank 4, but may be provided at some remote location(s).

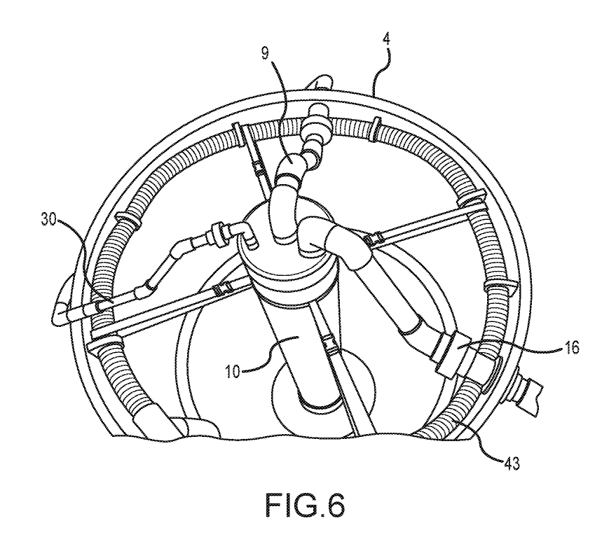

FIG. 6 is a top view of a tank 4 and exchanger 10. As shown, the exchanger 10 is provided within the tank 4 and comprises a substantially vertical column-type fluid-gas exchanger 10. The exchanger 10 comprises multiple inlets including an air conduit 9 to supply air or other gas to the exchanger 10 and a return line 30 to provide the exchanger 10 with fluid, such as a recirculated fluid from an internal volume of the tank 4 and/or aerated fluid from within with the exchanger 10. The exchanger 10 further comprises an outlet flow conduit 16 for allowing air or gas to vent outwardly from the exchanger 10. Such gas may be conveyed to a second stage tank 4 or digester, vented to the atmosphere, captured for later use, or disposed of in any number of desired ways.

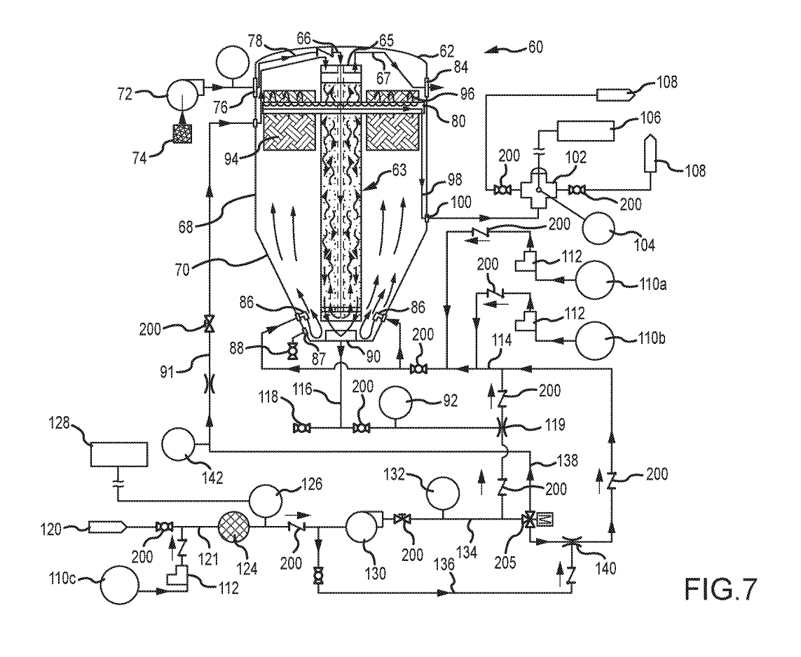

FIG. 7 is a schematic view of an alternative embodiment of the present disclosure. The system of FIG. 7 comprises a tank 60 with an internal volume. The system of FIG. 7 may comprise various features and devices as shown and described with respect to FIG. 1, even where such features are not shown in FIG. 7. As shown in FIG. 7, the tank 60 comprises an upper portion 68 and a lower portion 70. A lid or cover 62 is provided on the upper portion 68 and is preferably selectively removable by a user. The tank 60 further comprises a fluid-gas exchanger 63. The fluid-gas exchanger 63 preferably extends vertically within the interior volume of the tank 60. The fluid-gas exchanger 63 comprises a first conduit 65 and a second conduit 66. The embodiment depicted in FIG. 7 comprises a counter-flow aeration system wherein an exchanger 63 is provided as a counter-flow aeration tower. As shown, the exchanger 63 comprises a feature wherein water or fluid from the tank 60 is pumped from a lower region 70 of the tank 60 through tank outlet 90 and outlet line 92 by a recirculation pump 92 and returned to at least one of the internal volume of the tank 60 and the exchanger 63 via return line 91. A drain valve 118 is provided as an exit means for fluid and contents from the system. Water or fluid returned to the exchanger 63 via return line 91 is allowed to flow down to the base of the exchanger 63. Fluid, such as air, is pumped to the bottom of the exchanger 63 via blower 72, inlet 76 and inlet conduit 78 and allowed to flow upward through the exchanger to exit the top of the exchanger 63 via an outlet 84. A filter or screen 74 is preferably provided in combination with the blower 72. This system and process allows oxygen from ambient air, for example, to be provided in a water or fluid within the tank 60 to support aerobic digestion of organic material within the tank 60.

An air return flow is provided external to the internal conduit 66 but within the outer pipe 65. The internal conduit 66 comprises an outlet flow conduit 67 at an upper portion of the tank 60. The outlet flow through the conduit 67 comprises an air exhaust from the exchanger 63, and the exhausted air may be conveyed to an additional stage digester (if provided), exhausted into an outside environment, and/or may be re-directed into an internal volume of the tank 60 to a fluidized buoyant media 94. The fluidized buoyant media 94 is provided at an upper region of the tank 60 based on its buoyant characteristics. In various embodiments, the buoyant media comprises a biological material and generally corresponds to an area of anaerobic digestion within the tank. As shown in FIG. 7, a perforated outlet collector 80 is provided. The perforated outlet collector 80 preferably comprises a conduit that extends around at least a portion of the circumference of the tank, and comprises a plurality of apertures or ports for allowing liquid to be collected within the collector 80 and exit the tank 60 by means of outlet line 98 and outlet 100. The outlet line 100 is interconnected to an intersection or four-way valve 102 comprising a dissolved oxygen sensor 104. The intersection 102 comprises at least one and preferably two outlets 108, wherein fluid flow to at least one outlet is selectively regulated by one or more valves 200. In certain embodiments, a dissolved oxygen controller 106 is provided in combination with the intersection 102 such that dissolved oxygen of a fluid exiting the outlet collector 80 may be monitored and/or controlled.

Referring now to the outlet portions of the tank 60, a first outlet 87 with a drain valve 88 is provided to empty contents from an interior volume of the tank 60. Additionally, a primary outlet 90 of the tank 60 and/or exchanger 63 is provided to empty tank contents and, in certain embodiments, recirculate and recycle tank contents as may be desired. The primary outlet 90 is in communication with a pump 92, which may comprise a vacuum pump, to draw or accelerate fluid from the tank 60 and/or exchanger 63. In the depicted embodiment, the pump 92 conveys fluid to a flow restrictor 119 such as an eductor or similar device. The eductor (or similar) is provided to utilize a Bernoulli effect to withdraw or reduce sediment from the flow of fluid.

Fluid from the eductor 119 is preferably provided back to impingement nozzles 86 through a conduit or return line 114. Accordingly, fluid from the outlet 90 may either be emptied from the tank, or circulated through the pump 92 and flow restrictor 119 and re-injected into the interior volume of the tank by way of the nozzle(s) 86.

As shown in FIG. 7, the system also comprises means for injecting unused, fresh, or clean chemicals and fluids into the system. For example, certain embodiments of the present disclosure contemplate that the system is provided with at least one and preferably a plurality of solution tanks 110a, 110b, which preferably comprise one or more liquids, chemicals, and/or solutions for selective injection into the tank 60. The solution tanks 110a, 110b and contents contained therein are each provided in fluid communication with an injection pump 112. The injection pumps 112 are operable to pump or convey fluid from a solution tank 110 to an interior volume of the tank 60 by way of the return line 114 and nozzle(s) 86. The injection pumps may comprise any one or more of various known pumps including, for example, peristaltic pumps, nutrient injection pumps, microbe injection pumps, and other pumps as will be recognized by one of ordinary skill in the art. In various embodiments, the injection pumps 112 comprise a rheostat or similar device for controlling and metering an injection of the contents of the solution tank 110. In addition to or in lieu of such devices, the system preferably also comprises valves 200 between the solution tanks 110 and the tank 60 to adjust and/or terminate the amount of fluid flow from the solutions tanks 110 to the tank 60.

As further shown in FIG. 7, the system comprises a primary fluid inlet 120. The primary fluid inlet 120 is provided, for example, for tank filling operations and to add clean fluid (e.g. water) when needed. A solution tank 110c is provided proximal to and in optional fluid communication with an inlet line 120 to provide a solution or chemical for injection into the system. In various embodiments, an inlet line or path 121 comprises an inlet screen or filter 124 and/or a pH sensor. The pH sensor and inlet line 121 may further be provided with a pH controller 128 such that the pH of an inlet fluid may be monitored and/or regulated. A recirculation pump 130 is also provided to further convey fluids and interconnect with the return line 114 to provide fluid to the tank 60. A pressure indicator 132 is shown at a location prior to intersection with the return line 114. It will be recognized, however, that one or more pressure indicators may be provided at various points in the system to monitor pressure. A bypass line 136 is provided and selectively activated or controlled by at least one valve 200. The bypass line is provided to direct a fluid around a three-way valve 205 and through an educator 140 prior to reentering the tank 60. Eductors, as will be recognized by one of skill in the art, comprise various devices for removing sediment from a fluid in the system by utilizing pressure changes or suction within the device. For the purposes of the present disclosure, eductors include but are not limited to Venturi tubes and Venturi pumps. The three-way valve 205 is operable to direct fluid to an oxygenator supply line 138, which is provided with a rotameter 142. The three-way valve 205 is also operable to direct a fluid flow to the nozzle(s) 86 through either or both of a first educator 119 and a second educator 140 prior to entering the tank 60.

In the embodiment depicted in FIG. 7, a plurality of valves 200 is provided. These valves 200 are provided to selectively control flow rates at various points in the system, and are not limited to any particular valve. Indeed, valves 200 may comprise any one or more of in-line valves, ball valves, gate valves, multi-directional valves, plug valves, globe valves, needle valves, diaphragm valves, butterfly valves, and other valves as will be recognized by one of ordinary skill in the art. Additionally, valve placement and positioning is indicated in FIG. 7, but it will be recognized that the number and positioning of valves may be varied by one of ordinary skill in the art.

Influent nozzles 86 are provided at the bottom of the tank 60. The nozzles provide and combine a high-velocity water flow and an air bubble scour to remove accumulated biomass from bio-media that has sunk or descended to the bottom of the tank, as well as providing a means for injecting or supplying water into the tank 60. The embodiment shown in FIG. 7 thus eliminates the need for a cone or separated section provided in the tank, as is contemplated by alternative embodiments of the disclosure. As shown in FIG. 7, a lower region of the tank comprises a media cleaning zone, wherein aerated water inlets are provided and directed downwardly toward a bottom of the tank. Water and air injected into a lower region of the tank is allowed to flow or circulate upwardly toward a perforated outlet collector, and treated outlet fluid may be directed away from the tank.

Although various figures of the present disclosure, including FIG. 7, provide various details including conduits, fluid supply lines, valve, metering devices, measuring devices, etc., it will be expressly recognized that inventive aspects of the present disclosure reside in portions of the depicted systems. FIG. 7, for example, shows various features and specific combinations of features. It is contemplated, however that at least some of these features may be substituted or removed from the system and the contemplated inventions of the present disclosure should not be viewed as comprising each and every feature of any of the individual figures.

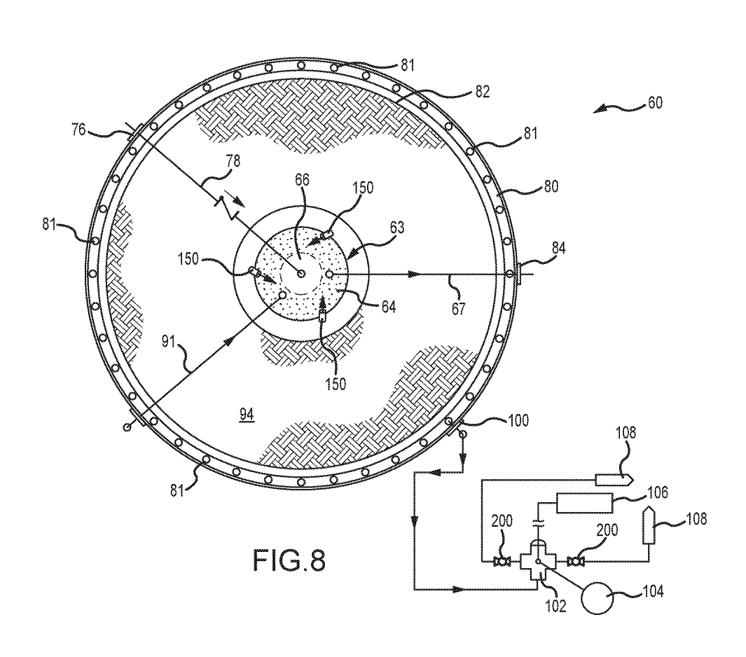

FIG. 8 is a top view of a tank 60 and related features according to the embodiment provided in FIG. 7. As shown, the tank 60 comprises a packed column 63 with forced-draft counter-flow aeration capabilities provided approximately in the center of the tank 60. The column 63 comprises at least one fluid inlet 91, at least one air inlet 78, and an air exhaust outlet 67, 84. The air exhaust outlet 84 may be connected to additional tanks and treatment devices provided upstream or downstream from the depicted tank. A buoyant bio media 94 as shown and described herein is provided around and exterior to the packed column 63. A media-retaining perforated outlet collector 80 is provided proximal an outer perimeter of the tank. The media-retaining perforated outlet collector 80 comprises a perforated pipe or conduit extending around a substantial entirety of the perimeter of the tank, and is provided to prevent treatment media from migrating out of the tank. The perforated outlet collector 80 comprises a plurality of apertures or inlets 81 and at least one outlet 100 for fluid wherein water and material may be transferred away from the tank 60 to a second stage digester, storage, discharge, etc. A plurality of inlets 150 are provided and arranged to circulate an entering volume of fluid into the exchanger 63.

In the embodiment provided in FIGS. 7-8, the substantial entirety of the tank comprises an aerobic environment, wherein recirculation at the bottom of the tank is not provided or enabled. Oxygenated water with entrained air is pumped to the bottom of the tank and allowed to travel upward to a ring outlet distributor proximal to the top of the tank. Additional tanks or vessels are contemplated as being provided in fluid communication with the tank of FIG. 7, and the additional tanks may operate as extensions of the aerobic zone or operate as partially or fully anoxic and anaerobic zones.

It should be recognized that various features shown and described with respect to certain figures are not limited to such figures or embodiments. Indeed, various features, devices, and arrangements of such features and devices shown and/or described with respect to one embodiment may be included or provided with additional or alternative embodiments.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

What is claimed is:

1. A treatment system for treating a liquid, the system comprising:
a tank comprising an upper portion, a lower portion, an interior volume, and a maximum fill level;
the upper portion of the tank comprising a substantially cylindrical portion and the lower portion comprising at least one of a conical portion and a frustoconical portion;
the tank comprising a first outlet for tank contents, the first outlet provided in the lower portion of the tank;
a fluid-gas exchanger provided at least partially within the interior volume of the tank, the fluid-gas exchanger operable to allow for interaction of at least one liquid and at least one gas, wherein an upper portion of the fluid-gas exchanger extends above the maximum fill level;
the fluid-gas exchanger comprising a second outlet;
a blower provided in fluid communication with a first inlet of the fluid-gas exchanger, the blower operable to direct an airflow into the fluid-gas exchanger;
a pump in selective fluid communication with the first outlet and the second outlet, and wherein the pump is operable to direct a fluid from at least one of the first outlet and the second outlet to the interior volume of the tank, a location external to the tank, and to a second inlet of the fluid-gas exchanger; and
at least one valve in fluid communication with the pump to selectively change a fluid flow path.

2. The treatment system of claim 1, further comprising a cabinet, the cabinet comprising at least one of a control system, a power connection, a storage area, a stored fluid, and a user interface for the treatment system.

3. The treatment system of claim 1, further comprising a nozzle provided within the interior volume of the tank, the nozzle operable to inject a fluid into the interior volume.

4. A treatment system for treating a liquid, the system comprising:
a tank with an interior volume;
the tank comprising a first outlet for discharging tank contents, the outlet provided in a lower portion of the tank and wherein tank contents are gravity fed to the first outlet;
a fluid-gas exchanger provided in fluid communication with the tank, the fluid-gas exchanger comprising a first conduit and a second conduit;
wherein the first conduit comprises an air entry path and the second conduit comprises a fluid flow path, and wherein the first conduit is provided within the second conduit;
a blower provided in fluid communication with the fluid-gas exchanger, the blower operable to direct an airflow into the fluid-gas exchanger;
a pump for directing fluid from the first outlet to at least one of the interior volume of the tank, a location external to the tank, and to an inlet of the fluid-gas exchanger;
the fluid-gas exchanger comprising a second outlet, the second outlet in selective fluid communication with the interior volume of the tank and an inlet of the fluid-gas exchanger.

5. The treatment system of claim 4, wherein the thank comprises a cylindrical upper portion and a conical lower portion.

6. The treatment system of claim 4, Wherein the first conduit extends between the blower and a location proximal to a bottom of the tank.

7. The treatment system of claim 4, further comprising a third conduit extending between the pump and an inlet of the fluid-gas exchanger, the third conduit operable to convey fluid from at least one of a lower region of the tank and a lower region of the fluid-gas exchanger to at least one of an upper region of the tank and an upper region of the fluid-gas exchanger.

8. The treatment system of claim 4, further comprising at least one tunable valve for directing at least one of a liquid and a gas within the treatment system.

9. The treatment system of claim 4, wherein the fluid-gas exchanger comprises at least one vertical tube.

10. The treatment system of claim 4, further comprising a cabinet, the cabinet comprising at least one of a control system, a power connection, a storage area, a stored fluid, and a user interface for the treatment system.

11. The treatment system of claim 4, further comprising a perforated cone provided within the internal volume of the tank,

12. The treatment system of claim 4, further comprising a nozzle provided within the interior volume of the tank, the nozzle operable to inject a fluid into the interior volume.

13. A treatment system for treating a liquid, the system comprising:
a tank comprising an upper portion, a lower portion, an interior volume and having a maxi mum fill level;
the upper portion comprising a substantially cylindrical portion and the lower portion comprising one of a conical portion and a frustoconical portion;
the tank comprising a first outlet for tank contents, the first outlet provided in the lower portion of the tank;
a fluid-gas exchanger provided at least partially within the interior volume of the tank, the fluid-gas exchanger operable to allow for interaction of at least one liquid and at least one gas, and wherein an upper portion of the fluid-gas exchanger extends above the maximum fill level of the tank;
a blower provided in fluid communication with a first inlet of the fluid-gas exchanger, the blower operable to direct an airflow into the fluid-gas exchanger;
a pump for directing fluid from at least one of the first outlet to the interior volume of the tank, a location external to the tank, and to a second inlet of the fluid-gas exchanger.

14. The treatment system of claim 13, wherein fluid-gas exchanger comprises a first conduit and a second conduit.

15. The treatment system of claim 14, further comprising a third conduit extending between the pump at least one of the first and second inlet of the fluid-gas exchanger, the third conduit operable to convey fluid from at least one of a lower region of the tank and a lower region of the fluid-gas exchanger to at least one of an upper region of the tank and an upper region of the fluid-gas exchanger.

16. The treatment system of claim 13, further comprising at least one tunable valve for directing at least one of a liquid and gas within the treatment system.

17. The treatment system of claim 13, wherein the fluid-gas exchanger comprises at least one tube provided in the center of the tank.

18. The treatment system of claim 13, further comprising a cabinet, the cabinet comprising at least one of a control system, a power connection, a storage area, a stored fluid, and a user interface for the treatment system.

19. The treatment system of claim 13, further comprising a cone filter provided within the internal volume of the tank.

20. The treatment system of claim 13, further comprising a nozzle provided within the interior volume of the tank, the nozzle operable to inject a fluid into the interior volume.
